(19) United States
(12) Patent Application Publication
(10) Pub. No.: US 2009/0020634 A1
(43) Pub. Date: Jan. 22, 2009

(54) FLEXIBLE DIAPHRAGM FOR AN IRRIGATION SYSTEM

(75) Inventors: Abraham Schweitzer, Kibbutz Hatzerim (IL); Tsipora Yankovitz, Kazir (IL); Izhar Halahmi, Hod-Hasharon (IL)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Netafim Ltd., Tel Aviv (IL)

(21) Appl. No.: 12/136,397

(22) Filed: Jun. 10, 2008

Related U.S. Application Data
(60) Provisional application No. 60/950,748, filed on Jul. 19, 2007.

(51) Int. Cl. B05B 12/08

(52) U.S. Cl. 239/542; 427/255.6

(57) ABSTRACT

A flexible diaphragm for an irrigation system includes a core layer and at least one protective layer formed on the core layer. The core layer may have specific chemical and physical properties, and the protective layer may be formed of specific materials.

### RELATED APPLICATIONS

The present application claims priority to U.S. Provisional Application No. 60/950,748, filed Jul. 19, 2007, whose contents are incorporated by reference in their entirety.

### BACKGROUND

The present disclosure relates to diaphragms and in particular to diaphragms used in irrigation systems.

An example of such a diaphragm can be found in U.S. Pat. No. 6,568,607 which describes a drip irrigation emitter with a diaphragm that is assembled inside a conduit. An increase of water pressure in the conduit deforms the diaphragm which in turn affects the flow of water available for dispersion through exist holes in the conduit.

Water used for irrigation may contain substances like chlorine chloramines, organic contaminants and/or surface active agents which may damage such diaphragms.

### SUMMARY

In one aspect, the present invention is directed to a flexible diaphragm for an irrigation system. The flexible diaphragm includes a core layer and at least one protective layer formed on the core layer.

### BRIEF DESCRIPTION OF THE FIGURES

Exemplary embodiments are illustrated in referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 shows a cross sectional view of a drip irrigation emitter incorporating a diaphragm in accordance with the present disclosure;

FIG. 2 shows an enlarged cross sectional view of the diaphragm; and

FIG. 3 shows a block diagram of a method for forming the diaphragm.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

The contents of aforementioned U.S. Pat. No. 6,568,607 are incorporated by reference to the extent necessary to understand the present invention.

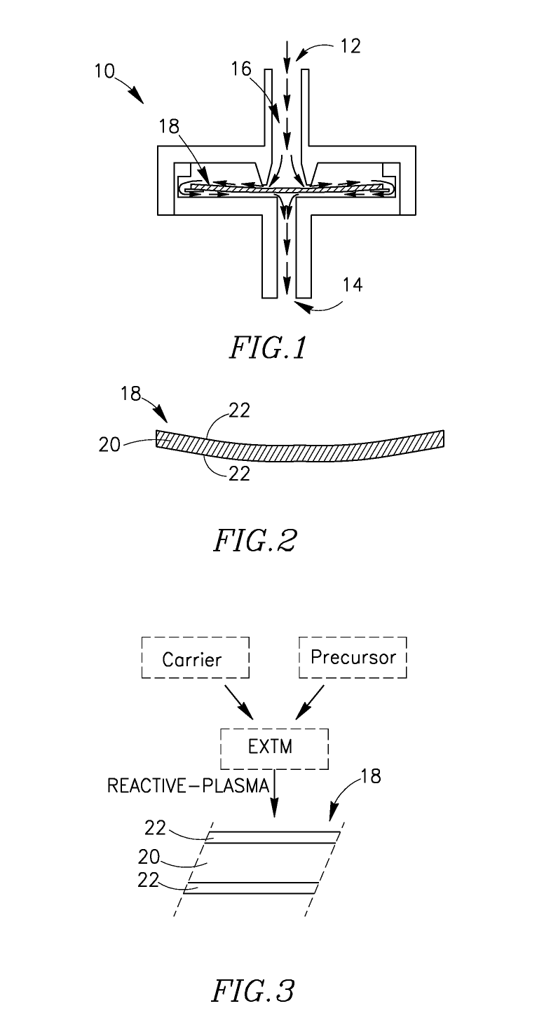

Attention is first drawn to FIG. 1. A drip irrigation emitter 10 has an inlet 12, an outlet 14 and a flow path 16 therebetween. A flexible diaphragm 18 which is located in the drip emitter 10 communicates with fluid passing via the flow path 16 to regulate the flow of fluid exiting the emitter 10 via the outlet 14. As seen in FIG. 1, the flexible diaphragm 18 is optionally positioned within the emitter 10 between the inlet 12 and the outlet 14 such that a fluid passing through the emitter 10 is forced to bear against the flexible diaphragm 18. The drip emitter 10 may be integrally or releasably attached to a conduit (not shown) in such a way that its inlet 12 is in fluid communication with the fluid passing through the conduit. Optionally, the emitter 10 is integrally bonded to the conduit.

It should be noted that the drip irrigation emitter 10 is only one example of an irrigation element that may utilize the diaphragm 18 in accordance with the present disclosure. Other non-limiting examples may include sprinklers, anti-drip valves or pressure regulators. In addition it is noted that the diaphragm 18 in accordance with the present disclosure may be utilized for functions other than regulating fluid flow. For example, the diaphragm 18 in accordance with the present disclosure may be used to seal a portion of an irrigation element.

Attention is draw to FIG. 2. The diaphragm 18 has a core layer 20 that is encompassed between external protective layers 22 that contact the fluid in the irrigation element 10. The core layer 20 is a polymer and/or compounds thereof, having a shore A hardness as measured at 20-25 degrees Celsius of between 30 to 85 and a thickness of between 100 micron to 5 millimeter. The core layer 20 is characterized by 2 percent secant flexural modulus, according to ASTM D790, of about 0.1 to 100 Mpa.

The core layer 20 may be formed from silicone, polyurethane, ethylene-propylene copolymers and terpolymers, ethylene-alpha olefin copolymers and terpolymers, ethylene-vinyl acetate, ethylene-acrylic (or methacrylic) ester copolymers and terpolymers, polysulfide, nitrile rubber, butadiene rubber, chlorinated rubber, natural rubber, SBR rubber, Styrene-butadiene-styrene (SBS), styrene-ethylene/butylene-styrene (SEBS), polyisoprene rubber (IR), thermoplastic vulcanizates (TPV), thermoplastic olefins (TPO), ionomer, polyether-block amide (PEBA), polyester, and any mixture thereof. In addition, the core 20 layer may comprise fillers, extenders, nano-size particles including nano-clays, plasticizers, processing aids, pigments, stabilizers, antioxidants, antiozonats, carbon black, oils, plasticizers and reinforcing particles and fibers. The polymer may be thermoplastic or cross-linked (thermoset).

The protective layers 22 are optionally deposited or applied on the core layer 20 using methods such as sputtering, Sol-gel, co-extrusion, melt coating, solvent-borne coating, 100% solid coatings, water borne coating, Chemical-vapor-deposition (CVD), or Physical-vapor-deposition (PVD). Optionally, the protective layer 22 is deposited on the core layer 20 using a plasma assisted deposition (referred to hereinafter as PAD) method. The plasma is generated by direct or alternate current. The plasma acts to implant its deposited compounds into the core layer 20 chains to thus form adhesion between the protective and core layers 20, 22.

Attention is drawn to FIG. 3. In the PAD method the following steps are optionally followed. A carrier inert gas such as Argon or Nitrogen is mixed with a gaseous compound such as FREON™ or Silicon tetra chloride, a monomer such as styrene, an ethylene or tetra ethoxy silane, or an oligomer such as silicone oil, that is a precursor for the protective layer. The precursor may be solid, liquid or gas at ambient pressure and temperature and may be selected in a non limiting example from silicone halides such as silicone tetra chloride, silicone alkoxides such as tetra ethoxy silane (TES), and titanium halides and alkoxides, zirconium halides and alkoxides, aluminum halides and alkoxides, fluorine atom containing molecules such as tetra fluoro carbon, FREON™. Optionally, the carrier and precursor are heated prior to mixing, during mixing or after mixing; in order to avoid phase separation.

The mixture is then transferred to an excitation module (referred to hereinafter as EXTM). The EXTM which is provided with electrical power activates and transforms the mixture into reactive-plasma which is then forced out of the EXTM through a slot or nozzle toward the core layer 18. The combination of reactive compounds in the reactive-plasma and the chemical nature of the compounds provide a dense, impermeable and optionally pin-hole free layer which is characterized by good adhesion to the core layer 20. The layer is usually cross linked by a process known in the art as plasma-polymerization which provides the layer with its chemical resistance and impermeability.

It is noted that the protective layer 22 has a thickness of up to 500 micron. In a protective layer 22 formed by a plasma based production method, the thickness is typically smaller and may reach a magnitude of several microns.

In the plasma based production methods, the protective layer 22 is a combination of a layer derived from the plasma ingredients and a hybrid layer which consists partly of the reactive-plasma and the core layer 20. The protective layer 22 therefore is characterized as having a higher concentration of atoms selected from silicon, titanium, aluminum, zirconium, fluorine, chlorine and combinations thereof, relative to the concentration of the same atoms in the middle of the core layer 20.

Once the diaphragm 18 is formed, to form the emitter 10 seen in FIG. 1, one provides a first portion in which the inlet 12 is formed, a second portion in which the outlet 14 is formed, places the diaphragm 18 between the two portions, and press fits or otherwise joins the two portions such that the diaphragm 18 is captured between the two portions.

The inventors have performed theoretical studies of the efficiency of the protective layer 22 to protect the core layer 20 of the diaphragm 18 from substances that may be found in fluid used in irrigation. The studies indicate that the permeability or sensitivity of a core layer 20 that is deposited by a protective layer 22 to chlorine ions is between 0.01 to 80 percent of the permeability or sensitivity of a similar core layer 20 without a protective layer 22 to similar ions, as measured at 20-25 degrees Celsius in aqueous medium. The studies in addition indicate that the permeability or sensitivity of a core layer 20 that is deposited by a protective layer 22 to iso-octane is between 0.01 to 80 percent of the permeability or sensitivity of a similar core layer 20 without a protective layer 22 to iso-octane, as measured at 20-25 degrees Celsius.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Although the present embodiment has been described to a certain degree of particularity, it should be understood that various alterations and modifications could be made without departing from the scope of the disclosure as hereinafter claimed.

What is claimed is:

1. An irrigation element flexible diaphragm of the sort suitable for positioning in an irrigation element comprising an inlet and an outlet such that a fluid passing through the irrigation element is forced to bear against said flexible diaphragm, the flexible diaphragm comprising:
a core layer; and
at least one protective layer formed on the core layer.

2. The irrigation element flexible diaphragm according to claim 1, wherein the shore hardness of the core layer as measured at 20-25 degrees Celsius is between 30-85 shore A.

3. The irrigation element flexible diaphragm according to claim 1, characterized by permeability or sensitivity to chlorine ions of at most 80% of the permeability or sensitivity of the core layer without the protective layer to chlorine ions as measured at 20-25 degrees Celsius in aqueous medium.

4. The irrigation element flexible diaphragm according to claim 1, wherein the protective layer is characterized by permeability or sensitivity to iso-octane of at most 80% of the permeability or sensitivity of the core layer without the protective layer to iso-octane as measured at 20-25 degrees Celsius.

5. The irrigation element flexible diaphragm according to claim 1, wherein the protective layer is characterized by higher concentration of atoms selected from silicon, titanium, aluminum, zirconium, fluorine, and combinations thereof relative to the core layer.

6. The irrigation element flexible diaphragm according to claim 1, wherein the protective layer is characterized by a thickness of up to 500 micron.

7. The irrigation element flexible diaphragm according to claim 1, wherein the core layer is characterized by a thickness of up to 5 millimeter.

8. The irrigation element flexible diaphragm according to claim 1, wherein the core layer comprises a polymer.

9. The irrigation element flexible diaphragm according to claim 8, wherein the polymer is selected from silicone, polyurethane, ethylene-propylene copolymers and terpolymers, ethylene-alpha olefin copolymers and terpolymers, ethylene-acrylic (or methacrylic) ester copolymers and terpolymers, polysulfide, nitrile rubber, butadiene rubber, neoprene rubber.

10. The irrigation element flexible diaphragm according to claim 1, wherein the flexible diaphragm communicates with fluid passing in the irrigation element to control the fluid flow out of the element.

11. The irrigation element flexible diaphragm according to claim 10, wherein the irrigation element is a drip emitter.

12. A method of making an irrigation element flexible diaphragm of the sort suitable for positioning in an irrigation element comprising an inlet and an outlet such that a fluid passing through the irrigation element is forced to bear against said flexible diaphragm, the method comprising:
providing a core layer; and
providing a protective layer on the core layer by a plasma assisted process.

13. The method according to claim 12, wherein the plasma assisted process comprises the steps of:
mixing a precursor and an inert gas,
providing the mixture to a plasma exciting module to form a reactive-plasma,
depositing the reactive-plasma on the core layer to provide the protective layer.

14. A method of making an irrigation element flexible diaphragm of the sort suitable for positioning in an irrigation element comprising an inlet and an outlet such that a fluid passing through the irrigation element is forced to bear against said flexible diaphragm, the method comprising:
providing a core layer; and
providing a protective layer on the core layer by using at least one of the methods of sputtering, Sol-gel, co-extrusion, chemical vapor deposition and/or physical vapor deposition.

15. An irrigation element comprising an inlet, an outlet, and a flexible diaphragm positioned in the irrigation element such that a fluid passing between the inlet and the outlet is forced to bear against said flexible diaphragm, the flexible diaphragm comprising:
a core layer; and
at least one protective layer formed on the core layer.

16. The irrigation element according to claim 15, wherein the irrigation element is a drip emitter.
